(19) United States
(12) Patent Application Publication
(10) Pub. No.: US 2026/0129136 A1
(43) Pub. Date: May 7, 2026

(54) IMAGE CAPTURE APPARATUS AND CONTROL METHOD

(71) Applicant: CANON KABUSHIKI KAISHA, Tokyo (JP)

(72) Inventor: MAKOTO YOKOZEKI, Kanagawa (JP)

(21) Appl. No.: 19/365,507

(22) Filed: Oct. 22, 2025

(30) Foreign Application Priority Data
Nov. 1, 2024 (JP) 2024-193200

(51) Int. Cl. H04N 1/32; H04N 21/435

(52) U.S. Cl. CPC H04N 1/32106; H04N 1/32128; H04N 21/4351; H04N 2201/3252

(57) ABSTRACT

An image capture apparatus includes a first generation unit that generates image data at a predetermined cycle, a second generation unit that generates metadata regarding processing up to generation of the image data, a first output unit that adds the metadata to the image data to output externally the image data, and a second output unit that outputs externally, a plurality of times, predetermined information generated until the image data in the metadata is output, before the image data is output by the first output unit.

### BACKGROUND

### Field of the Technology

The present disclosure relates to control for externally outputting information regarding image data.

### Description of the Related Art

A technique called visual effects (hereinafter, VFX) is known. VFX is a technique for compositing computer graphics (hereinafter, CG) with an actually shot image.

Cases of compositing a shot image with CG in VFX include a method of compositing CG generated in advance after the shot image is shot and a method of compositing, in real time, CG with the shot image sequentially shot. In the latter method, CG is composited with the shot image by using metadata associated with image data for each frame of the shot image, and a communication protocol called User Datagram Protocol (UDP) is often used because a real-time characteristic is emphasized.

Japanese Patent No. 7190594 describes a method in which a time code of metadata is output from an output unit different from an output unit that outputs image data added with a time code, whereby the time code of the metadata can be used even when the time code added to the image data cannot be correctly used.

UDP has a possibility that metadata of a certain frame is lost due to packet loss. In a case where packet loss occurs, since metadata of the lost frame cannot be used, there is a possibility that an unnatural image is generated.

### SUMMARY

The present disclosure has been made in consideration of the aforementioned problems, and provides technical advantages that can reduce generation of an unnatural image due to packet loss.

In order to solve the aforementioned problems, the present disclosure is directed to an image capture apparatus comprising: a first generation unit that generates image data at a predetermined cycle; a second generation unit that generates metadata regarding processing up to generation of the image data; a first output unit that adds the metadata to the image data to output externally the image data; and a second output unit that outputs externally, a plurality of times, predetermined information generated until the image data in the metadata is output, before the image data is output by the first output unit.

In order to solve the aforementioned problems, the present disclosure is directed to a control method of an image capture apparatus, the control method comprising: generating image data at a predetermined cycle; generating metadata regarding processing up to generation of the image data; adding the metadata to the image data to output externally the image data from a first output unit; and outputting externally, from a second output unit, a plurality of times, predetermined information regarding the image data generated until the image data in the metadata is output, before the image data is output from the first output unit.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capture apparatus according to a present embodiment.

FIG. 2 is a block diagram illustrating a configuration of an image processing apparatus according to the present embodiment.

FIG. 3 is a flowchart exemplifying control processing of the image capture apparatus of the present embodiment.

FIG. 4 is a view illustrating metadata output from the image capture apparatus of the present embodiment.

FIG. 5 is a view illustrating a description example of metadata output from the image capture apparatus of the present embodiment.

FIG. 6 is a flowchart exemplifying control processing of the image processing apparatus of the present embodiment.

FIGS. 7A-7D are views illustrating the operation from image capture processing to image data output processing of the image capture apparatus according to a first embodiment.

FIGS. 8A-8D are views illustrating the operation from image capture processing to image data output processing of the image capture apparatus according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present embodiment, an example will be described, in which in a system where an image capture apparatus and an image processing apparatus are communicatively connected, the image capture apparatus generates image data at a predetermined cycle (e.g., frame rate) and adds metadata regarding processing up to generation of the image data for each frame to the image data and outputs externally the image data, and the image processing apparatus combines, in real time, the image data and computer graphics (CG) data based on the image data and the metadata received from the image capture apparatus.

### First Embodiment

Next, a first embodiment will be described.

### Apparatus Configuration

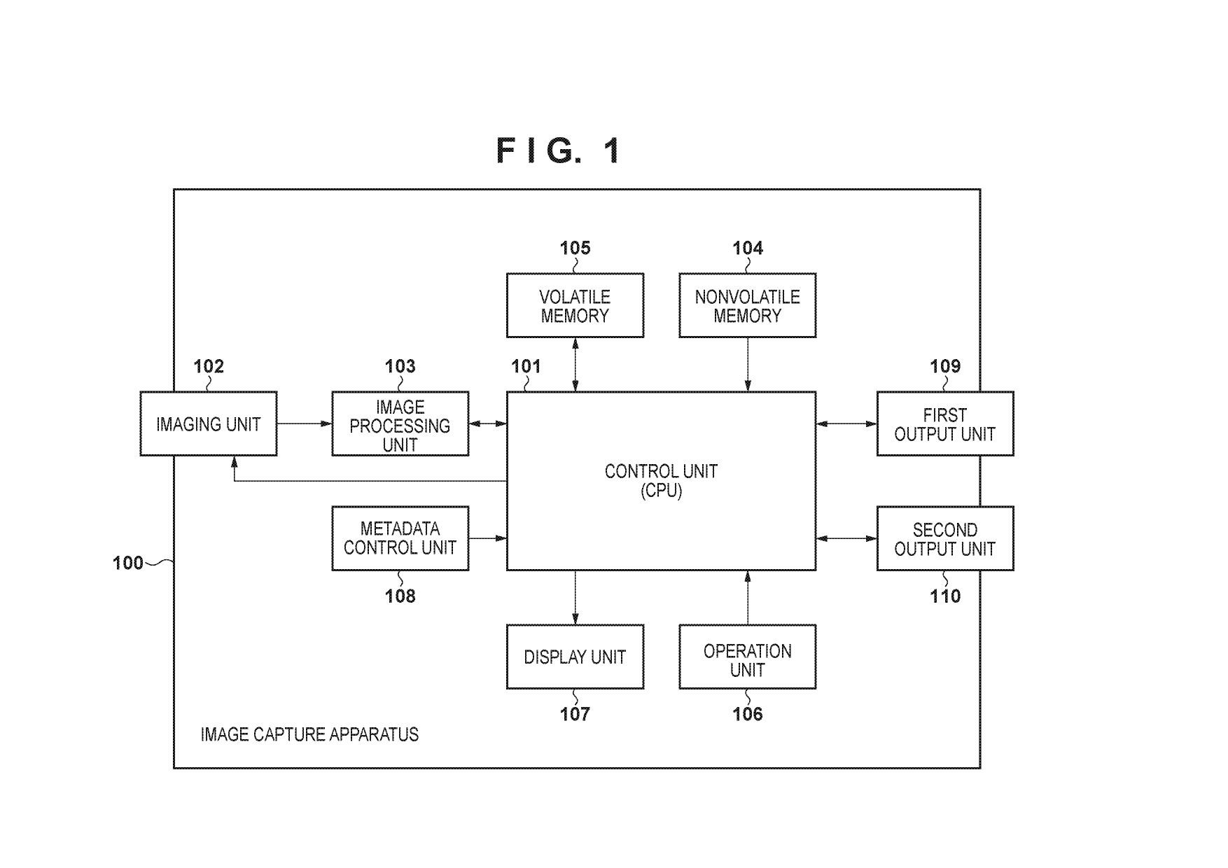

The configuration and the function of the image capture apparatus of the present embodiment will be described with reference to FIG. 1.

An image capture apparatus 100 of the present embodiment is, for example, a digital camera, a digital video camera, a smartphone, a tablet computer, or a WEB camera having a camera function and a communication function.

The function of the image capture apparatus 100 of the present embodiment is implemented by hardware illustrated in FIG. 1 and/or a program of software to be executed by a control unit 101.

The control unit 101 is an arithmetic processing processor such as Central Processing Unit (CPU) or Micro Processing Unit (MPU) that integrally controls the entire image capture apparatus 100, and implements control processing described later by executing a program stored in a nonvolatile memory 104 described later. Note that, instead of the control unit 101 controlling the entire apparatus, controlling the entire apparatus may be performed by a plurality of units of hardware sharing the processing.

An imaging unit 102 includes an image capture optical system. The image capture optical system includes a lens group including a zoom lens and a focus lens, and a shutter having an aperture function. The imaging unit 102 includes an image sensor including Charge-Coupled Device (CCD) or Complementary Metal Oxide Semiconductor (CMOS) device that converts a subject image into an electric signal, and an A/D converter that converts an analog image signal output from the image sensor into a digital signal. Under the control of the control unit 101, the imaging unit 102 converts subject image light formed by a lens included in the imaging unit 102 into an electric signal by the image sensor, performs noise reduction processing and the like, and outputs a digital image signal. Note that the image capture optical system including the lens group and the shutter may be removable from the image capture apparatus 100.

An image processing unit 103 includes a graphics processing unit (GPU), and executes various types of image processing on an image signal generated by the imaging unit 102. The image processing unit 103 compresses and encodes, by JPEG or the like, still image data subjected to image processing, or encodes moving image data by a moving image compression method such as MPEG2 or H.264 to generate an image file, and records the image file into a recording medium such as a memory card. The image processing unit 103 performs predetermined arithmetic processing using the image signal generated by the imaging unit 102, and the control unit 101 controls the focus lens, aperture, and the shutter of the imaging unit 102 based on an obtained arithmetic result, thereby performing autofocus (AF) processing and auto exposure (AE) processing.

The image processing executed by the image processing unit 103 includes pre-processing, color interpolation processing, correction processing, detection processing, data processing, evaluation value calculation processing, and special effect processing.

The pre-processing includes signal amplification, reference level adjustment, and defective pixel correction.

The color interpolation processing is processing of interpolating values of color components that cannot be obtained at the time of shooting, and is also called demosaic processing.

The correction processing includes processing such as white balance adjustment, gradation correction, correction of image degradation due to optical aberration of the image capture optical system (image recovery), correction of influence of peripheral darkening of the image capture optical system, and color correction.

The detection processing includes detection of motion in a characteristic region (e.g., face region or body region) or a specific region and recognition processing of a person.

The data processing includes processing such as compositing (combining), scaling, encoding and decoding, and header information generation (data file generation). The data processing also includes generation of image data according to uses such as display, recording, and external output.

The evaluation value calculation processing includes processing such as generation of a signal and an evaluation value used for automatic focus detection (AF) and generation of an evaluation value used for automatic exposure control (AE).

The special effect processing includes processing such as addition of a blurring effect, change of a color tone, and re-lighting.

Note that the above-described image processing is an example and does not limit the processing to be executed by the image processing unit 103.

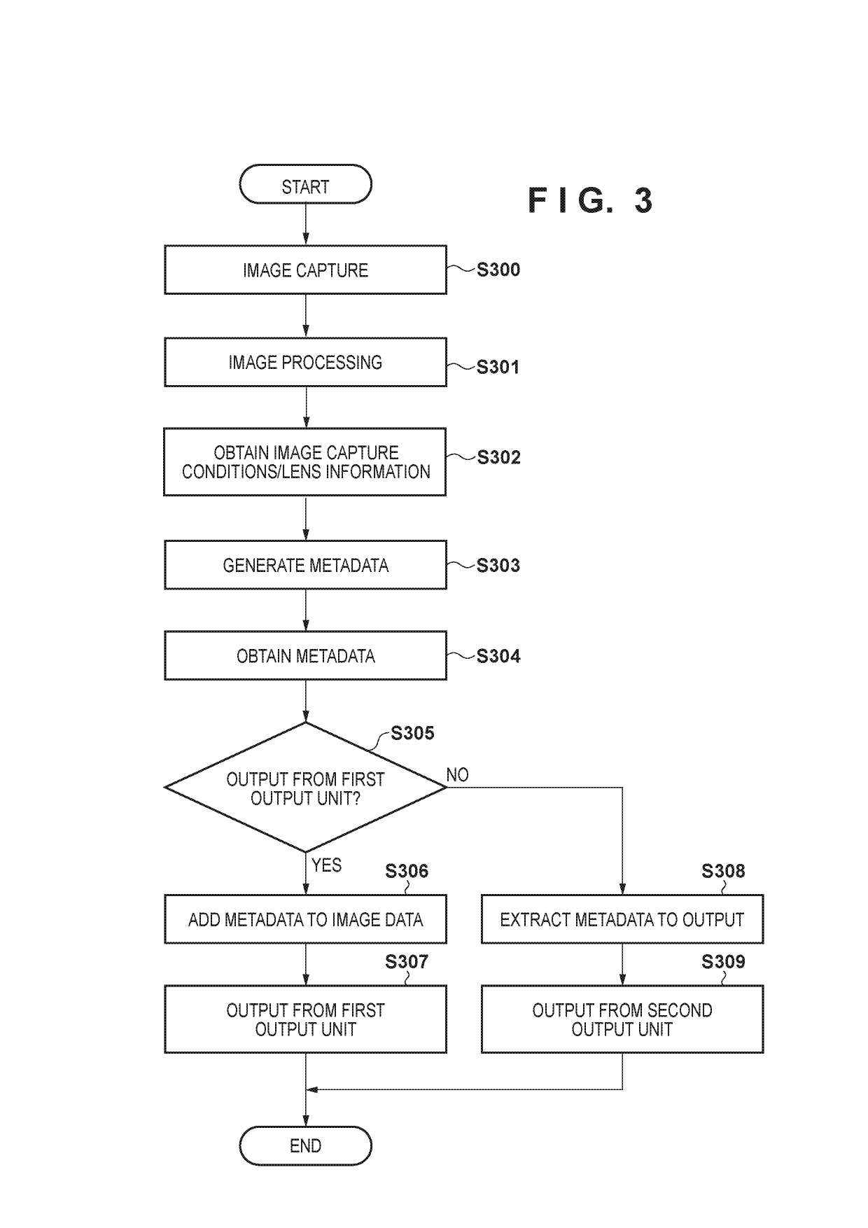

The nonvolatile memory 104 is a flash memory, a solid state drive (SSD), a hard disk drive (HDD), or the like that enables data to be erased or written. The nonvolatile memory 104 records constants, programs, and the like for operation of the control unit 101. The program mentioned here is a program for executing control processing described later with reference to FIG. 3.

A volatile memory 105 is a RAM that temporarily stores a program read out from the nonvolatile memory 104, constants and variables for executing the program, and the like. The volatile memory 105 is also used as a working memory of the control unit 101, the image processing unit 103, and a metadata control unit 108. The volatile memory 105 is used as a buffer memory that temporarily holds an image signal generated by the imaging unit 102, image data processed by the image processing unit 103, metadata generated by the metadata control unit 108, and the like, and an image display memory of a display unit 107.

An operation unit 106 is an input device such as various switches, buttons, and dials that receive various operations from a user, and outputs operation information to the control unit 101. The operation unit 106 includes, for example, a power supply button for turning on or off the power supply, a shooting button for instructing start or end of shooting of a still image or shooting of a moving image, a reproduction button for instructing reproduction of an image, and a mode switching button for changing an operation mode of the image capture apparatus 100. The operation unit 106 includes a dedicated connection button or the like for starting communication with an external apparatus such as an image processing apparatus 200 described later. Note that functions assigned to an identical input device may be variable. The input device may be a software button or a key using a touch display.

In a mode of shooting a still image, autofocus (AF) processing and auto exposure (AE) processing are executed based on the image signal generated by the imaging unit 102. The control unit 101 executes shooting processing of recording, into a recording medium, still image data in which the image signal generated by the imaging unit 102 is subjected to image processing by the image processing unit 103.

In a mode of shooting a moving image, the control unit 101 executes autofocus (AF) processing and auto exposure (AE) processing based on the image signal for each frame generated by the imaging unit 102. The control unit 101 executes shooting processing of recording, into a recording medium, moving image data in which the image signal generated by the imaging unit 102 is subjected to image processing by the image processing unit 103. The control unit 101 starts shooting processing of moving image data in response to the shooting button being pressed initially, and continues the shooting processing of the moving image data until the shooting button is pressed again. The control unit 101 stops shooting processing of moving image data in response to the shooting button being pressed again, and records, into the recording medium, moving image data for the time from starting to stopping the shooting processing.

The display unit 107 performs display of a live view image generated by the imaging unit 102, display of a shot image, display of an image to be reproduced, display of a graphical user interface (GUI) for receiving a user operation, and the like. The display unit 107 is, for example, a display device such as a liquid crystal display or an organic EL display. The display unit 107 may have a configuration integrated with the image capture apparatus 100 or may be an external apparatus connected to the image capture apparatus 100. The image capture apparatus 100 may be able to be connected to the display unit 107 and able to control display of the display unit 107.

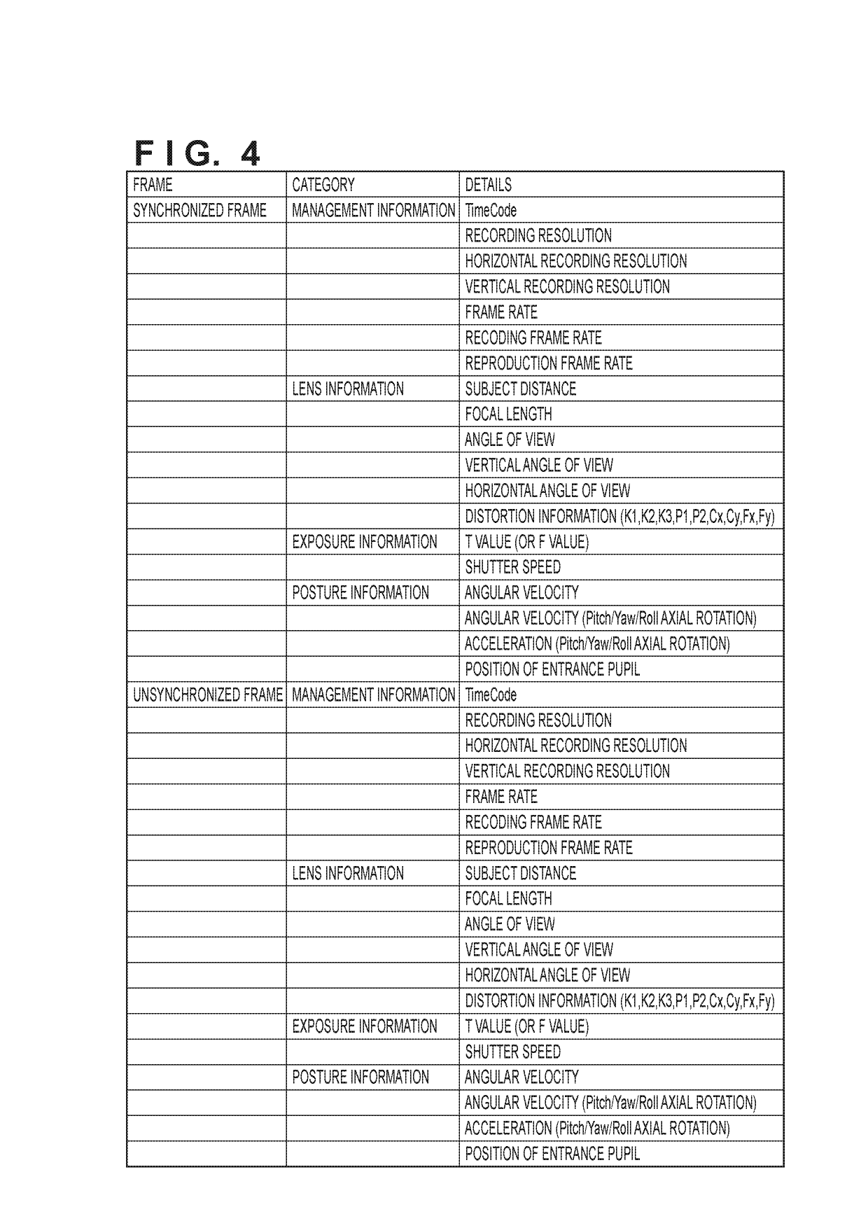

The metadata control unit 108 generates associated information regarding processing until image data is generated in parallel to image capture processing executed by the imaging unit 102. The associated information is metadata including information regarding image capture processing and information regarding image data generated by image capture processing. The metadata includes, but is not limited to, a time code, a recording time, an image capture condition, lens information, and a posture of the image capture apparatus 100, which will be described later with reference to FIG. 4. The image capture condition includes a focal length and an angle of view of the image capture optical system, sensitivity, a shutter speed, an exposure time, and a frame rate. The lens information includes a distortion parameter representing a degree of distortion of the lens, manufacturing error information of the lens, and a lens name. The metadata control unit 108 extracts, from generated metadata, metadata used for real-time composite processing of compositing image data generated at a predetermined frame rate with CG data generated in advance.

A first output unit 109 adds metadata to the image data captured by the imaging unit 102 and processed by the image processing unit 103, and outputs externally the image data. In the present embodiment, the first output unit 109 outputs, but is not limited to, image data in compliance with a video signal transmission standard called Serial Digital Interface (SDI).

A second output unit 110 outputs externally metadata generated by the metadata control unit 108. The metadata to be output from the second output unit 110 includes at least information (e.g., time code, lens information, and the like) used for real-time composite processing of image data with CG data executed by the image processing apparatus 200. In the present embodiment, the second output unit 110 outputs, but is not limited to, metadata using a communication protocol called User Datagram Protocol (UDP) compliant with a communication standard called Ethernet (registered trademark).

The signal transmission standard, the communication standard, and the communication protocol with which the first output unit 109 and the second output unit 110 of the present embodiment are compliant are examples, and other standards and communication protocols may be used. A wired communication method or a wireless communication method may be used. The first output unit 109 and the second output unit 110 have a configuration corresponding to a compliant standard (connector, antenna, transmission-reception circuit, and the like).

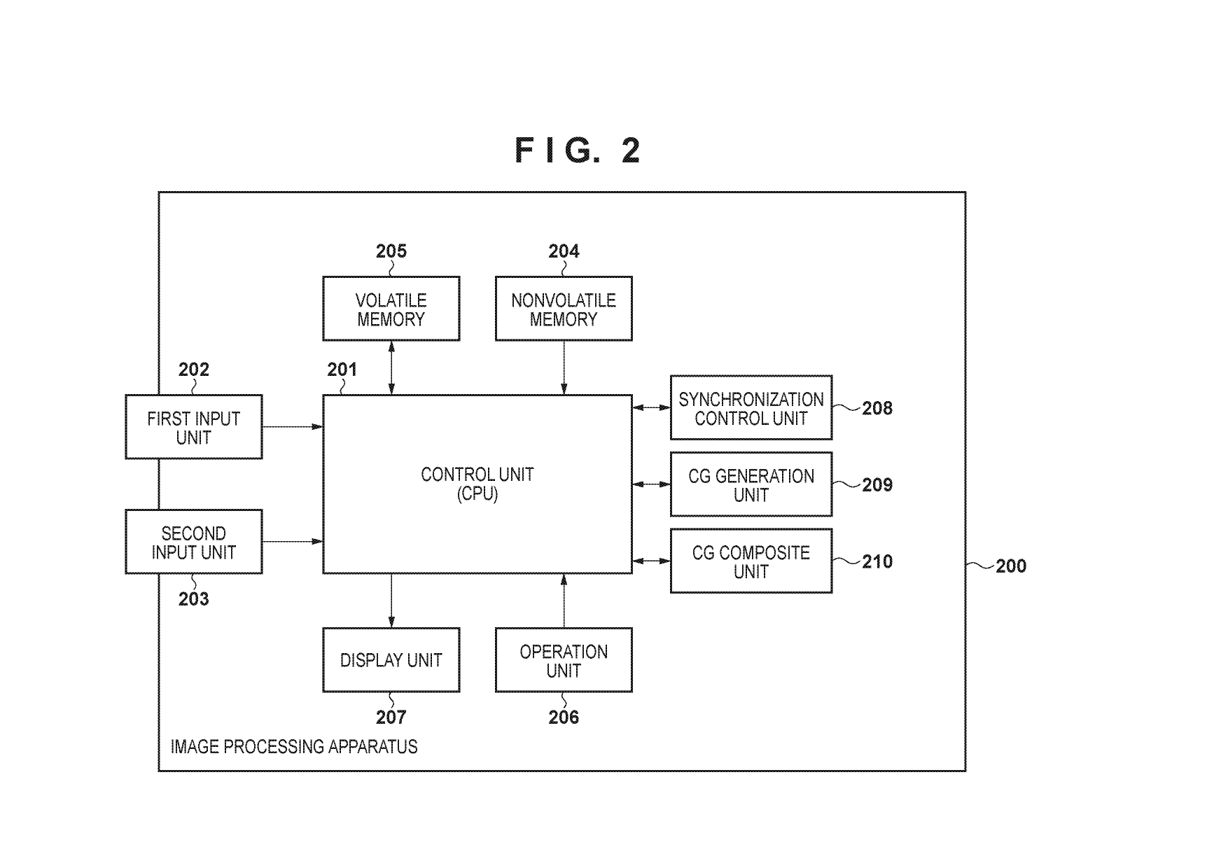

The configuration and the function of the image processing apparatus according to the present embodiment will be described with reference to FIG. 2.

The image processing apparatus 200 of the present embodiment is a general-purpose computer such as a personal computer (PC) or a tablet computer, or a dedicated computer such as a server computer.

The function of the image processing apparatus 200 of the present embodiment is implemented by hardware illustrated in FIG. 2 and/or a program of software to be executed by a control unit 201.

The image processing apparatus 200 of the present embodiment performs real-time composite processing of compositing CG data with image data using image data and metadata received from the image capture apparatus 100.

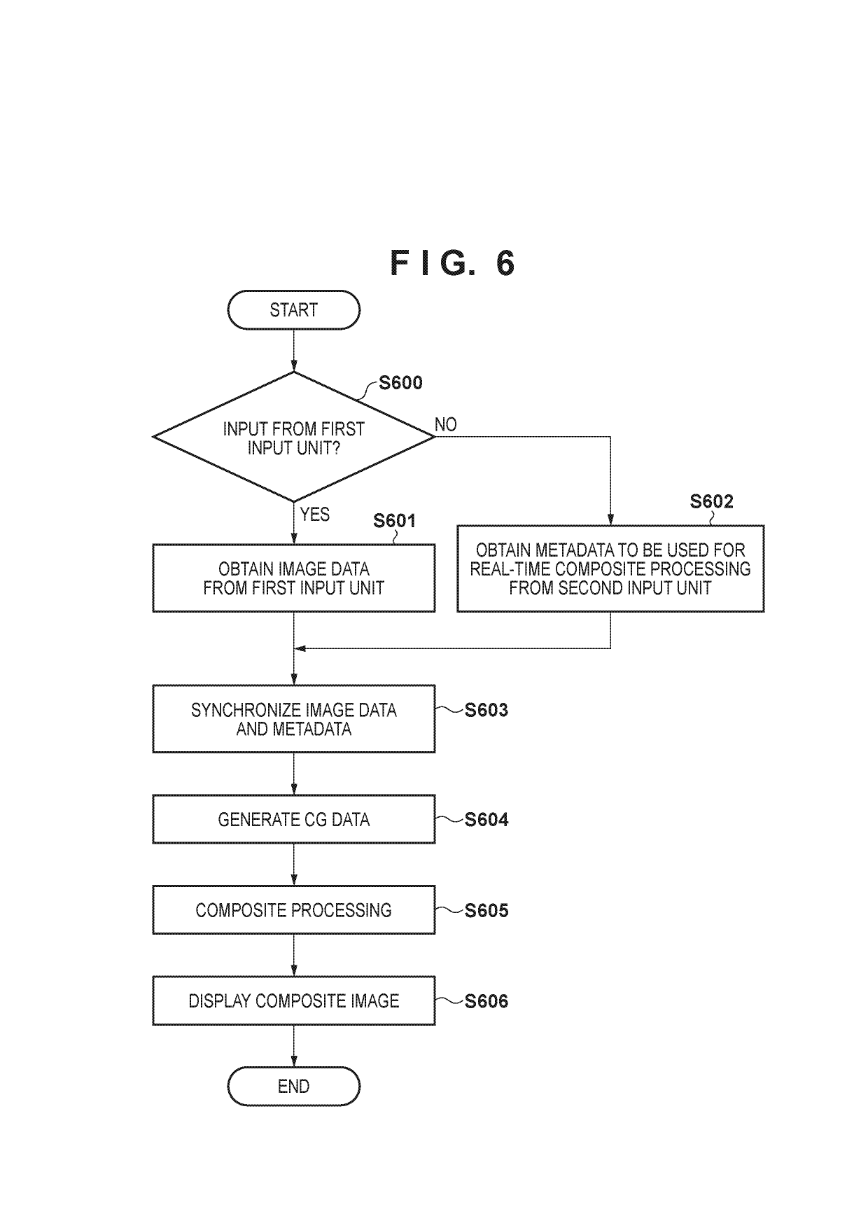

The control unit 201 is an arithmetic processing processor such as a CPU or an MPU that integrally controls the entire image processing apparatus 200, and implements control processing described later by executing a program stored in a nonvolatile memory 204 described later in FIG. 6. Note that, instead of the control unit 201 controlling the entire apparatus, the entire apparatus may be controlled by sharing the processing among a plurality of units of hardware.

The nonvolatile memory 204 is a flash memory, a solid state drive (SSD), a hard disk drive (HDD), or the like that enables data to be erased or written. The nonvolatile memory 204 records an operating system (OS) that is basic software executed by the control unit 201 and an application that implements an application function in cooperation with this OS. In the present embodiment, the nonvolatile memory 204 stores an application for the image processing apparatus 200 to implement control processing and real-time composite processing described later.

The processing of the image processing apparatus 200 of the present embodiment is implemented by reading software provided by an application. Note that it is assumed that the application includes software for using the basic function of the OS installed in the image processing apparatus 200. Note that the OS of the image processing apparatus 200 may include software for implementing the processing in the present embodiment.

A volatile memory 205 is a RAM that temporarily stores a program read out from the nonvolatile memory 204, constants and variables for executing the program, and the like. The volatile memory 205 is also used as a working memory for the control unit 201, a CG generation unit 209, and a CG composite unit 210. The volatile memory 205 is used as a buffer memory that temporarily holds image data and metadata received from the image capture apparatus 100, CG data generated by the CG generation unit 209, composite image data generated by the CG composite unit 210, and the like. The volatile memory 205 is used as an image display memory of a display unit 207.

An operation unit 206 is an input device such as a mouse, a keyboard, or a touch pad that receives a user operation, and outputs operation information to the control unit 201. Note that functions assigned to an identical input device may be variable. The input device may be a software button or a key using a touch display.

The control unit 201 executes processing in accordance with the operation of the operation unit 206. For example, the control unit 201 executes start and end of an application, processing in accordance with the operation on a GUI provided by the application, and the like.

The display unit 207 displays a GUI provided by the OS or the application. The display unit 207 displays, through the GUI, setting information of the image processing apparatus 200, image data received by a first input unit 202, CG data generated by the CG generation unit 209, composite image data generated by the CG composite unit 210, and the like. The display unit 207 is, for example, a display device such as a liquid crystal display or an organic EL display. The display unit 207 may have a configuration integrated with the image processing apparatus 200 or may be an external apparatus connected to the image processing apparatus 200. The image processing apparatus 200 may be able to be connected to the display unit 207 and able to control display of the display unit 207.

The first input unit 202 is directly or indirectly connected to the first output unit 109 of the image capture apparatus 100. The first input unit 202 receives image data added with metadata via the first output unit 109 of the image capture apparatus 100. In the present embodiment, the first input unit 202 receives, but is not limited to, data in compliance with High-Definition Multimedia Interface (HDMI) (registered trademark) standard.

A second input unit 203 is directly or indirectly connected to the second output unit 110 of the image capture apparatus 100. The second input unit 203 receives metadata output from the second output unit 110 of the image capture apparatus 100. In the present embodiment, the second input unit 203 outputs, but is not limited to, metadata using a communication protocol called User Datagram Protocol (UDP) compliant with a communication standard called Ethernet (registered trademark). The metadata to be received by the second input unit 203 includes metadata used to combine, in real time, image data received by the first input unit 202 with CG data generated by the CG generation unit 209.

The signal transmission standard, the communication standard, and the communication protocol with which the first input unit 202 and the second input unit 203 of the present embodiment are compliant are examples, and other standards and communication protocols may be used. A wired communication method or a wireless communication method may be used. The first input unit 202 and the second input unit 203 have a configuration corresponding to a compliant standard (connector, antenna, transmission-reception circuit, and the like).

A synchronization control unit 208 controls synchronization between metadata received by the second input unit 203 and image data received by the first input unit 202.

The CG generation unit 209 generates CG data to be composited with image data received by the first input unit 202 by using metadata received by the second input unit 203.

The CG composite unit 210 combines CG data generated by the CG generation unit 209 with image data received by the first input unit 202, and generates composite image data.

### Control Processing

Next, control processing of the image capture apparatus 100 of the present embodiment will be described with reference to FIG. 3.

The processing of FIG. 3 is implemented by the control unit 101 loading a program stored in the nonvolatile memory 104 into the volatile memory 105 and executing the program, and controlling each component of the image capture apparatus 100.

In the present embodiment, it is assumed that the image capture apparatus 100 is set in advance so as to perform image capture processing at a predetermined frame rate and output externally image data generated by the image capture processing in real time together with metadata. In the present embodiment, a transmission standard (data format) of image data, a type of metadata to be externally output, and the like are also set in advance.

In step S300, the control unit 101 causes the imaging unit 102 to start image capture processing. The control unit 101 controls the imaging unit 102 so as to capture a moving image at a predetermined frame rate. Thereafter, the imaging unit 102 continues image capture of the moving image until the end of image capture is instructed. The control unit 101 continuously executes exposure control during image capture and focus control of the image capture optical system based on an evaluation value obtained from the image processing unit 103, for example.

In step S301, the control unit 101 controls the image processing unit 103 so as to generate image data in a format to be output externally from the image signal of each frame output by the imaging unit 102. The image processing unit 103 applies necessary image processing to the image signal and generates image data in a format corresponding to an external output setting. The image processing unit 103 sequentially stores the generated image data into the volatile memory 105.

In step S302, the control unit 101 obtains the image capture conditions set in steps S300 and S301 and lens information from the imaging unit 102 and the image processing unit 103, and stores them into the volatile memory 105 in association with the image data of the frame generated by the image capture processing.

The metadata to be used for real-time composite processing includes, for example, information (lens information) regarding the image capture optical system and posture information of the image capture apparatus 100. For example, parameters regarding development processing and the like are image capture conditions obtained by performing image processing with respect to a frame after readout. Aperture values, distortion parameters, and the like are lens information for a frame during exposure, and shutter speeds and the like are image capture conditions for a frame to start exposure in the next image capture processing.

Even if these pieces of information can be obtained at the same time, frames to be associated with these pieces of information are different, and therefore the obtained pieces of information are stored in association with respective frames scheduled to be synchronized. This can output, in advance, some metadata with respect to image data to be output after certain image data at the timing of outputting the image data.

Note that, in the present embodiment, a time code is used as metadata for associating (synchronizing) image data output from the first output unit 109 with metadata output from the second output unit 110. Use of the time code can specify which frame and metadata correspond to each other by the frame number of the time code output from the second output unit 110 and the frame number of the time code added to the image data output from the first output unit 109.

In step S303, the control unit 101 causes the metadata control unit 108 to start generation of metadata. The metadata control unit 108 reads out the time code of metadata to be added to the image data stored in the volatile memory 105, and generates the metadata based on information corresponding to the time code among the image capture conditions and the lens information stored in the volatile memory 105 in step S302. Furthermore, the metadata control unit 108 reads out, from the volatile memory 105, information corresponding to time codes at the next frame of the above-described time code and subsequent frames, and generates metadata in association with those time codes. The metadata control unit 108 stores the generated metadata into the volatile memory 105.

Note that in the metadata stored in the volatile memory 105, the metadata associated with an identical time code to the time code added to the image data is initialized because it is no longer used the next time and thereafter. That is, the metadata stored in the volatile memory 105 and sequentially updated is held and output until the image data synchronized with the time code of the metadata is output from the first output unit 109.

In step S304, the control unit 101 sequentially obtains, from the volatile memory 105, the metadata generated by the metadata control unit 108.

In step S305, the control unit 101 determines whether or not the metadata obtained in step S304 is the metadata output from the first output unit 109. When the metadata obtained in step S304 is the metadata output from the first output unit 109, the control unit 101 supplies it to the first output unit 109, and when the metadata is not the metadata output from the first output unit 109, the control unit 101 supplies it to the second output unit 110.

Note that it is assumed that the relationship between the type of metadata and the corresponding output unit is registered in the nonvolatile memory 104 in advance in a table format, for example. Note that metadata is associated with at least one of the first output unit 109 and the second output unit 110, and may be associated with both of the output units.

Only the type of metadata to be output to the first output unit 109 may be registered, and unregistered metadata may be supplied to the second output unit 110. The correspondence relationship between the metadata and the output unit may be changeable by the user.

Steps S306 and S307 are processing of the first output unit 109, and steps S308 and S309 are processing of the second output unit 110.

In step S306, the first output unit 109 adds the metadata supplied from the control unit 101 to the moving image data stored in the volatile memory 105, and generates output data according to the output format. In the present embodiment, the first output unit 109 generates output data in the SDI format added with metadata as ancillary data.

In step S307, the first output unit 109 outputs externally the output data generated in step S306.

In step S308, the second output unit 110 extracts the metadata to be output among the metadata supplied from the control unit 101. It is assumed that the metadata to be output is set in advance. The metadata to be output includes at least metadata necessary for compositing, in real time, the image data output from the first output unit 109 with CG data, and metadata for associating (synchronizing) the output of the first output unit 109 with the output of the second output unit 110.

Note that the metadata necessary for the real-time composite processing may be notified to the image capture apparatus 100 from an external apparatus (image processing apparatus 200) that executes the real-time composite processing, or may be registered in the image capture apparatus 100 in advance. For example, when an application for performing real-time composite processing is executed in the image processing apparatus 200, the control unit 201 notifies the control unit 101 of information regarding necessary metadata. The control unit 101 may register, into the second output unit 110, the type of metadata notified by the control unit 201, or may store it in, for example, the volatile memory 105 so that the second output unit 110 can refer to it.

In step S309, the second output unit 110 stores, into a UDP packet, the metadata extracted in step S308 and outputs it.

Thereafter, the above-described operation is continuously executed until a stop condition of external output such as a user instruction is satisfied. In the present embodiment, metadata generation and output are performed in parallel to image capture processing, but the present disclosure is not limited to this, and the metadata may be generated and output only for the frame to be recorded in response to a recording instruction to record the image data obtained by the image capture processing. That is, the operation in and after step S301 may be started on the image data to be recorded in a case where a recording start instruction is received in step S300, and then the operations in steps S301 to S309 may be continuously executed until a recording stop instruction is received.

FIG. 4 illustrates metadata to be output for each frame of image data from the image capture apparatus 100 at the time of shooting a moving image.

The metadata includes management information, which is information regarding a moving image, lens information, which is information regarding a state of the image capture optical system at the time of shooting, exposure information, which is information regarding exposure conditions at the time of shooting, and posture information regarding the posture of the image capture apparatus 100 at the time of shooting.

These pieces of information include, in addition to the metadata synchronized with the image data output from the first output unit 109, the information that is the metadata scheduled to be synchronized in the future with image data having not been output from the first output unit 109 and that can be obtained by the control unit 101 (information regarding a not-yet-synchronized frame in FIG. 4).

Note that the data configuration of FIG. 4 is an example, and other information may be included or a part of the data of FIG. 4 needs not be included. FIG. 4 illustrates only one piece of information regarding a not-yet-synchronized frame, but information regarding a plurality of not-yet-synchronized frames may be included.

In the example of FIG. 4, the information regarding a synchronized frame includes a time code as metadata for associating the output of the first output unit 109 with the output of the second output unit 110. The information regarding the not-yet-synchronized frame includes the time code of a frame scheduled to be synchronized. Note that the information is not limited to the time code, and may be a frame number or the like, or may be information corresponding to the time of a difference from the time code of the synchronized frame or the number of frames of the difference.

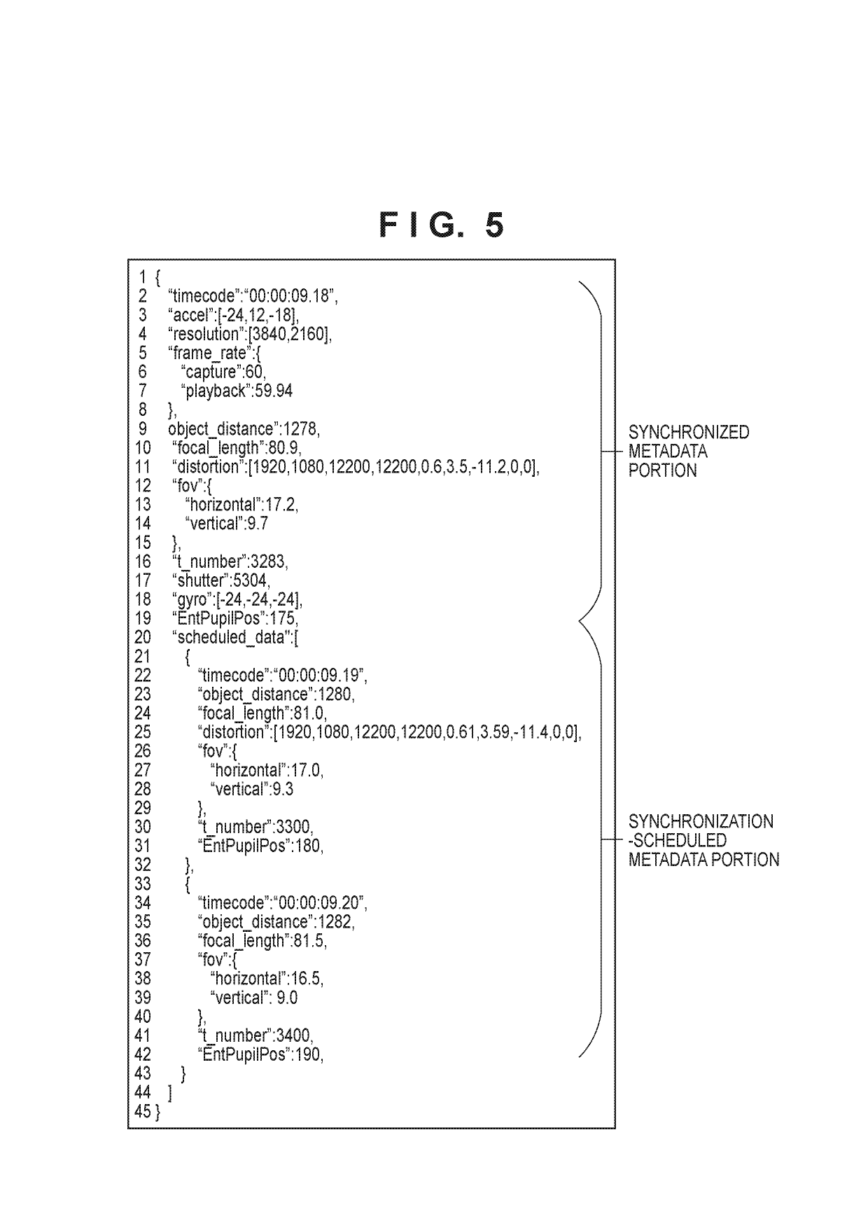

FIG. 5 illustrates an example in which the metadata illustrated in FIG. 4 is described in JavaScript Object Notation (JSON) format.

This is an example of description method that can be used when externally outputting metadata, and metadata may be described using another description method such as Extensible Markup Language (XML).

Hereinafter, for convenience of description, FIG. 5 will be described with line numbers. In the present embodiment, it is assumed that the image data in the frame where "timecode" is "00:00:09.18" is output from the first output unit 109 in synchronization with the timing at which the data illustrated in FIG. 5 is output from the second output unit 110.

First, data in lines 2 to 19 is data synchronized with the image data output from the first output unit 109 (hereinafter, synchronized metadata portion). The synchronized metadata portion is data including all pieces of information illustrated in FIG. 4.

Next, lines 20 to 44 are data regarding a frame that has not been output from the first output unit 109, but data having already been obtained by the control unit 101. In the present embodiment, "timecode" is structured (hereinafter, synchronization-scheduled metadata portion) as a collection of data "scheduled_data" as data to be synchronized with a frame after "00:00:09.18".

The data in lines 22 to 31 in the synchronization-scheduled metadata portion is data (hereinafter, synchronization-scheduled metadata portion after one frame) scheduled to be synchronized with the next frame ("timecode" is "00:00:09.19") of the frame synchronized with the synchronized metadata portion. Data in lines 34 to 42 is data (hereinafter, synchronization-scheduled metadata portion after two frames) scheduled to be synchronized with the frame ("timecode" is "00:00:09.20") two frames after the frame synchronized with the synchronized metadata portion.

In the example of FIG. 5, the synchronization-scheduled metadata portion after one frame and the synchronization-scheduled metadata portion after two frames are in a state where the control unit 101 can obtain only a predetermined part of the metadata illustrated in FIG. 4, but all the data in FIG. 4 may be obtained.

Next, control processing of the image processing apparatus 200 of the present embodiment will be described with reference to FIG. 6.

FIG. 6 illustrates processing in which the image processing apparatus 200 receives image data and metadata output from the image capture apparatus 100, and the image processing apparatus 200 executes real-time composite processing using the received image data and metadata.

Hereinafter, it is assumed that the first output unit 109 of the image capture apparatus 100 and the first input unit 202 of the image processing apparatus 200 are communicatively connected, and the second output unit 110 of the image capture apparatus 100 and the second input unit 203 of the image processing apparatus 200 are communicatively connected. It is assumed that image data in the SDI format output from the first output unit 109 of the image capture apparatus 100 is converted into the HDMI format by a converter or the like before reaching the first input unit 202. It is assumed that at least time codes of the metadata added to image data in the SDI format can be correctly recognized on the reception side also after being converted into the HDMI format.

The processing of FIG. 6 is implemented by the control unit 201 executing a real-time composite processing application stored in the nonvolatile memory 204 to control each component of the image processing apparatus 200.

In step S600, when the first input unit 202 or the second input unit 203 receives data from the external apparatus (image capture apparatus 100), the control unit 201 determines whether or not the data is input from the first input unit 202. The control unit 201 advances the processing to step S601 upon determining that the input is from the first input unit 202, and advances the processing to step S602 otherwise (upon determining that the input is from the second input unit 203).

In step S601, the control unit 201 receives the image data added with metadata by the first input unit 202, and stores the received image data and metadata into the volatile memory 205.

In step S602, the control unit 201 receives the metadata by the second input unit 203, and stores the received metadata into the volatile memory 205. At this time, the information of the synchronized metadata portion and the synchronization-scheduled metadata portion illustrated in FIG. 5 are partitioned into respective regions secured for each time code and stored in the volatile memory 205. When a part of the metadata related to the received time code is already received at the reception timing of previous metadata and stored in the volatile memory 205, the information of the existing metadata portion is updated or added by the data received this time. Note that the region for each time code secured in the volatile memory 205 includes a ring buffer, and when information on a region of a certain time code is used for real-time composite processing of image data received by the first input unit 202, the region is initialized as an unused region. The ring buffer secures a region that can sufficiently handle a difference in data reception timing by the first input unit 202 and the second input unit 203.

By the above processing, even in a case where the metadata output from the second output unit 110 of the image capture apparatus 100 disappears in the middle of a communication path and cannot be received by the second input unit 203 of the image processing apparatus 200, it is possible to restore a part or the entire of the synchronized metadata portion by using the previously received metadata.

In step S603, the control unit 201 transmits an instruction to the synchronization control unit 208 so as to start synchronization processing between the image data received by the first input unit 202 in step S601 and the metadata received by the second input unit 203 in step S602. The synchronization control unit 208 starts execution of the synchronization processing in response to the instruction received from the control unit 201, reads out the time code of the image data stored in the volatile memory 205 in step S601, and collates the time code with the time code of the metadata stored in the volatile memory 205 in step S602. Then, the synchronization control unit 208 synchronizes the image data with the metadata by reading out the metadata of the matched time code.

In the processing of FIG. 6, even in a case where the metadata synchronized with the image data cannot be received, since part or the entire of the metadata synchronized with the image data is stored in the volatile memory 205 by the metadata previously received a plurality of times, the image data and the metadata can be synchronized with each other.

Note that the synchronization method described above is an example, and synchronization can be performed by other methods.

Next, the control unit 201 supplies the CG composite unit 210 with image data for one frame from the image data and the metadata synchronized by the synchronization control unit 208, and supplies the CG generation unit 209 with metadata corresponding thereto.

In step S604, the CG generation unit 209 generates CG data to be composited with image data in the CG composite unit 210 based on the metadata supplied from the control unit 201. By rendering model data of CG prepared in advance based on posture information, lens information, and the like at the time of shooting of the image capture apparatus 100, the CG generation unit 209 generates CG data that is natural when composited with the image data. The CG generation unit 209 supplies the generated CG data to the CG composite unit 210 through the control unit 201.

In step S605, the CG composite unit 210 combines the image data for one frame supplied from the control unit 201 in step S603 and the CG data generated by the CG generation unit 209 in step S604, and generates composite image data of one frame. The CG composite unit 210 supplies the composite image data to the control unit 201.

In step S606, the control unit 201 stores the composite image data of one frame generated by the CG composite unit 210 into a video memory region of the volatile memory 205, and displays it on the display unit 207.

The processing of FIG. 6 described above is continuously executed until an end condition of the real-time composite processing is satisfied.

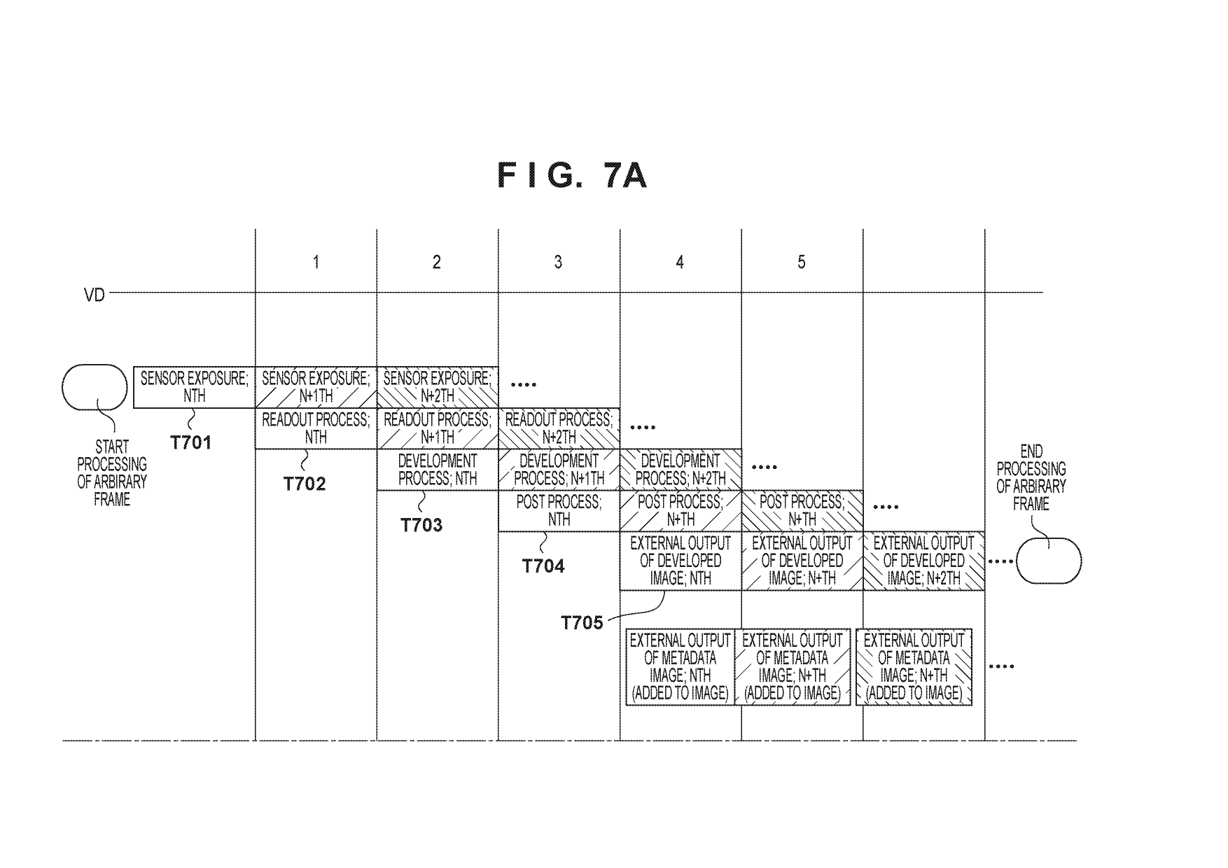

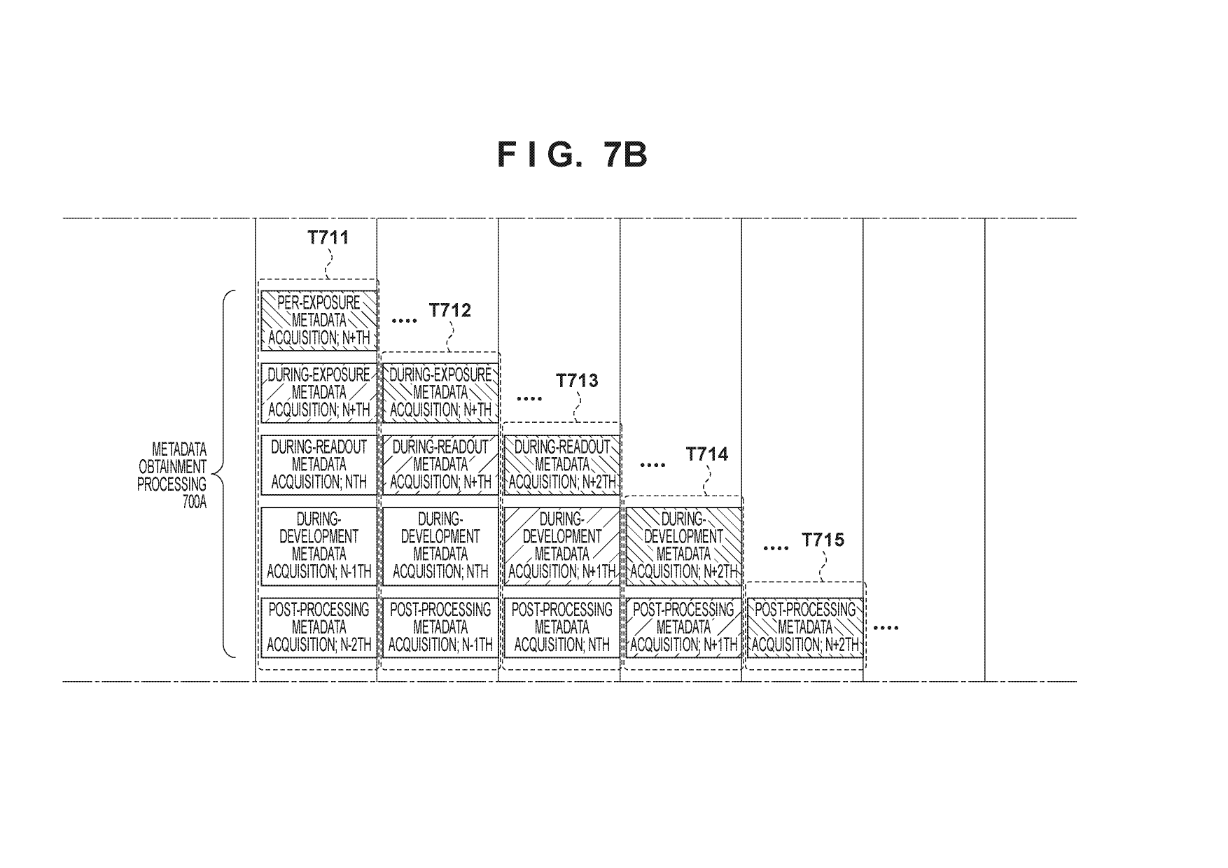

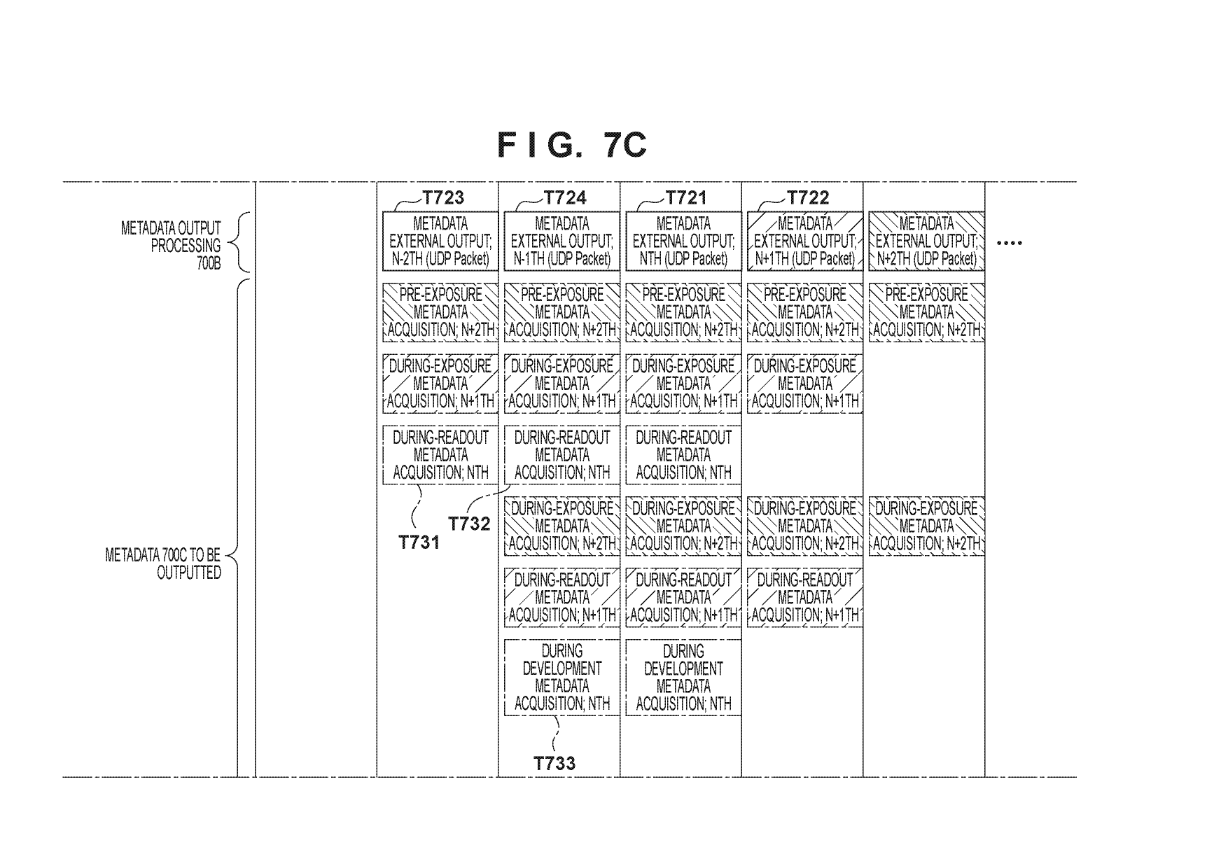

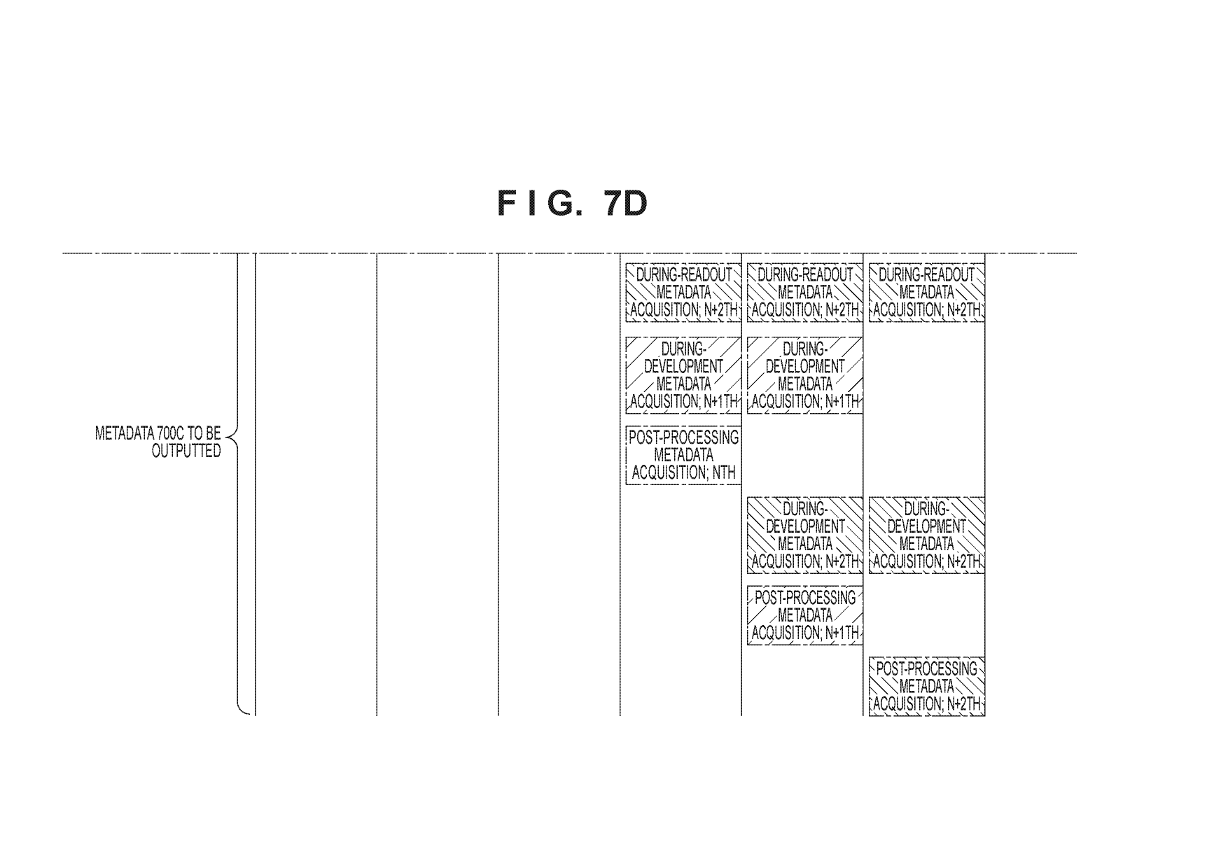

Next, the operation from image capture processing to image data output processing in the control processing of FIG. 3 of the image capture apparatus 100 of the present embodiment will be described with reference to FIGS. 7A-7D.

Hereinafter, for convenience of description, a description will be given with symbols from 1 to 5 for separation of each vertical synchronization signal (VD) when the image signal is read out from the image sensor of the imaging unit 102.

In image capture processing of a certain frame N (N is a natural number), exposure (hereinafter, sensor exposure) is performed by the image sensor at T701 at the timing of VD1.

At T702, the image signal is read out from the image sensor that performs exposure at T701 to obtain a RAW image signal. For the RAW image signal obtained at T702, development processing is performed at T703, post-processing is performed at T704, and image data developed at T705 and metadata added to the image data are externally output. Here, the metadata to be externally output is metadata of the synchronized frame including all the pieces of information in FIG. 4.

The operations of T701 to T705 are similar for the frame N + 1 and the frame N + 2 illustrated in FIG. 7A, and are similar for the frame N - 1 and the frame N - 2, which are frames before the frame N not illustrated in FIG. 7A.

Using the RAW image signal obtained by sensor exposure, the image capture apparatus 100 performs various types of image processing such as detection of exposure and color information, detection of the subject, and detection of a motion vector amount for use in blur correction.

In metadata obtainment processing 700A of FIG. 7B, at the timing of VD1, a shooting condition for performing the sensor exposure of the frame N + 2 at the timing of VD2 next to the sensor exposure of the frame N + 1 at T711 is obtained as pre-exposure metadata of the (N + 2)th frame. The pre-exposure metadata includes a shutter speed, for example. At the timing of VD1, the shooting condition and the lens information corresponding to the frame N + 1 currently being exposed are obtained as in-exposure metadata of the (N + 1)th frame. The in-exposure metadata includes information regarding a distortion parameter and a manufacturing error, for example, and position information of the image capture apparatus 100. Furthermore, at the timing of VD1, the shooting condition and the lens information corresponding to the Nth frame on which readout processing is being performed are obtained as in-readout metadata of the Nth frame. The in-readout metadata includes parameters related to processing executed at the time of readout such as sensitivity, for example. Furthermore, although not illustrated, the shooting condition and the lens information corresponding to the (N - 1)th frame on which development processing is performed at the timing of VD1 are obtained as developing metadata of the (N - 1)th frame. The developing metadata includes white balance information, for example. Furthermore, although not illustrated, the shooting condition and the lens information corresponding to the (N - 2)th frame on which post-processing is performed at the timing of VD1 are obtained as post-processing metadata of the (N - 2)th frame. The post-processing metadata includes electronic image stabilization information, for example.

The metadata obtainment processing performed at T711 has been described above, and at T712, T713, T714, and T715, the metadata obtainment processing described at T711 is similarly performed on frames of +1, +2, +3, and +4 with respect to the frame of T711.

After the metadata obtainment processing of each frame is performed at the timing of T711 to T715 described above, metadata output processing 700B of T721 to T724 is performed.

Describing the metadata output processing for the frame N at T721 as an example, the metadata (metadata 700C to be output described below T721) already obtained at T721 is externally output as a UDP packet. Note that the timing at which the metadata of T721 is output is synchronized with the timing at which the image data of the frame N is output at T705, and even if the metadata regarding the frame N is output at and after this timing, the real-time composite processing cannot be performed on the image data of the frame N. Therefore, the metadata regarding the frame N is not externally output on the frames at and after the metadata synchronized with the image data of the frame N is externally output as a UDP packet. That is, the metadata to be externally output at T722 is only the metadata regarding the frames at and after the frame N + 1.

Next, a case where the metadata externally output from the second output unit 110 of the image capture apparatus 100 disappears in the middle of the communication path and cannot be received by the second input unit 203 of the image processing apparatus 200 by the operations of FIGS. 7C-7D will be described.

For example, a case where the metadata regarding the frame N externally output at T721 has disappeared will be considered.

When the metadata externally output at T721 disappears, the image processing apparatus 200 cannot receive the metadata regarding the frame N. However, in a case where the metadata regarding the frame N externally output at T723 or T724 before T721 can be received, a part of the metadata regarding the frame N (metadata output at T731, T732, and T733) can be received, and therefore real-time composite processing can be performed using a part of the metadata regarding the frame N already received. This can reduce rendering of an unnatural image.

Note that, in the present embodiment, an example in which a part of the metadata necessary for the real-time composite processing is output from the second output unit 110 has been described in order to facilitate understanding, but the problem that the metadata output from the image capture apparatus 100 cannot be used by the external apparatus is not limited to the real-time composite processing. Therefore, in order to solve the problem of the present embodiment, it is necessary to be able to repeatedly output, a plurality of times, part or the entire of a plurality of types of metadata generated at the time of image capture until image data synchronized with the metadata is output.

### Second Embodiment

Next, a second embodiment will be described.

In the second embodiment, in addition to the metadata output processing 700B of FIG. 7C, processing 800B for immediately outputting metadata is added, and the other apparatus configuration and control processing are similar to those of the first embodiment.

In the second embodiment, an example will be described in which metadata is sequentially output from the second output unit 110 in association with a frame scheduled to be synchronized not only at the timing when metadata synchronized with a frame is output from the first output unit 109 as in the first embodiment but also at the timing when the control unit 101 obtains metadata of the frame scheduled to be synchronized from the imaging unit 102 or the image processing unit 103.

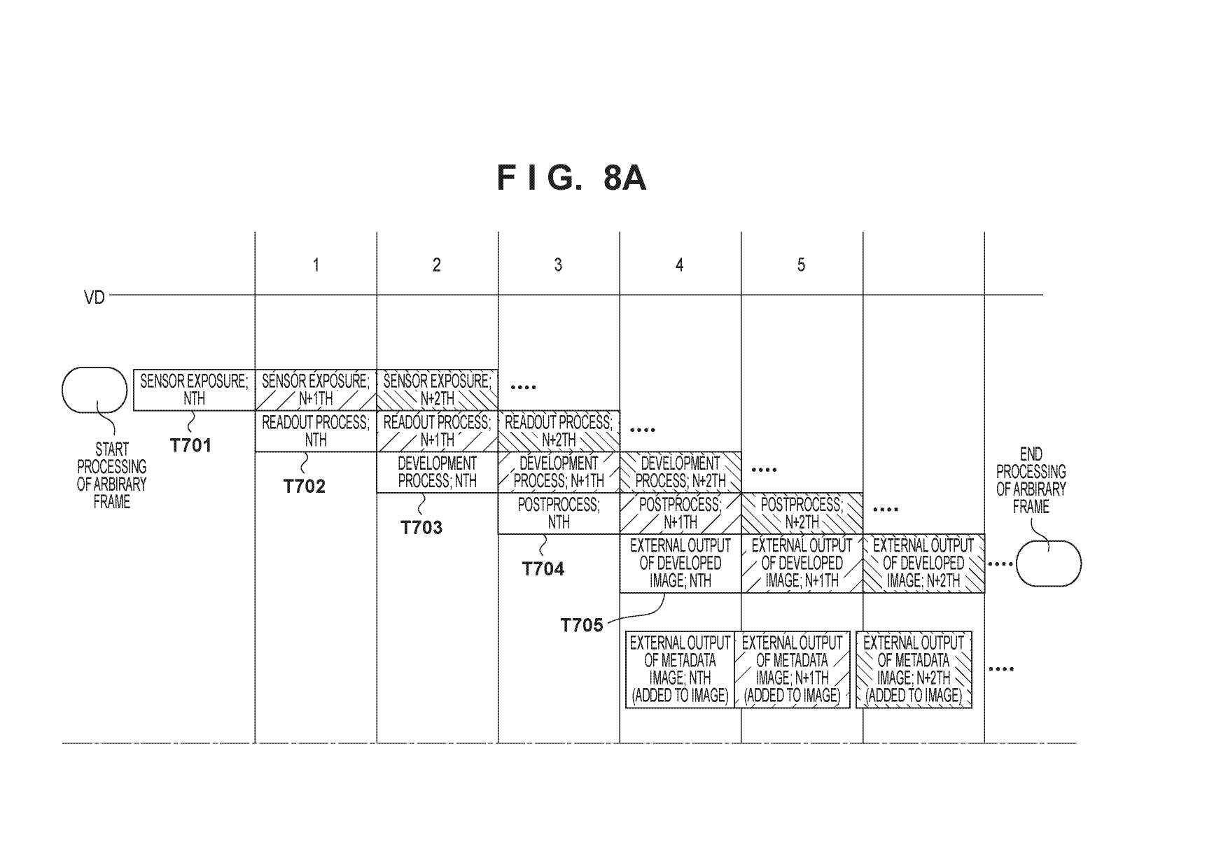

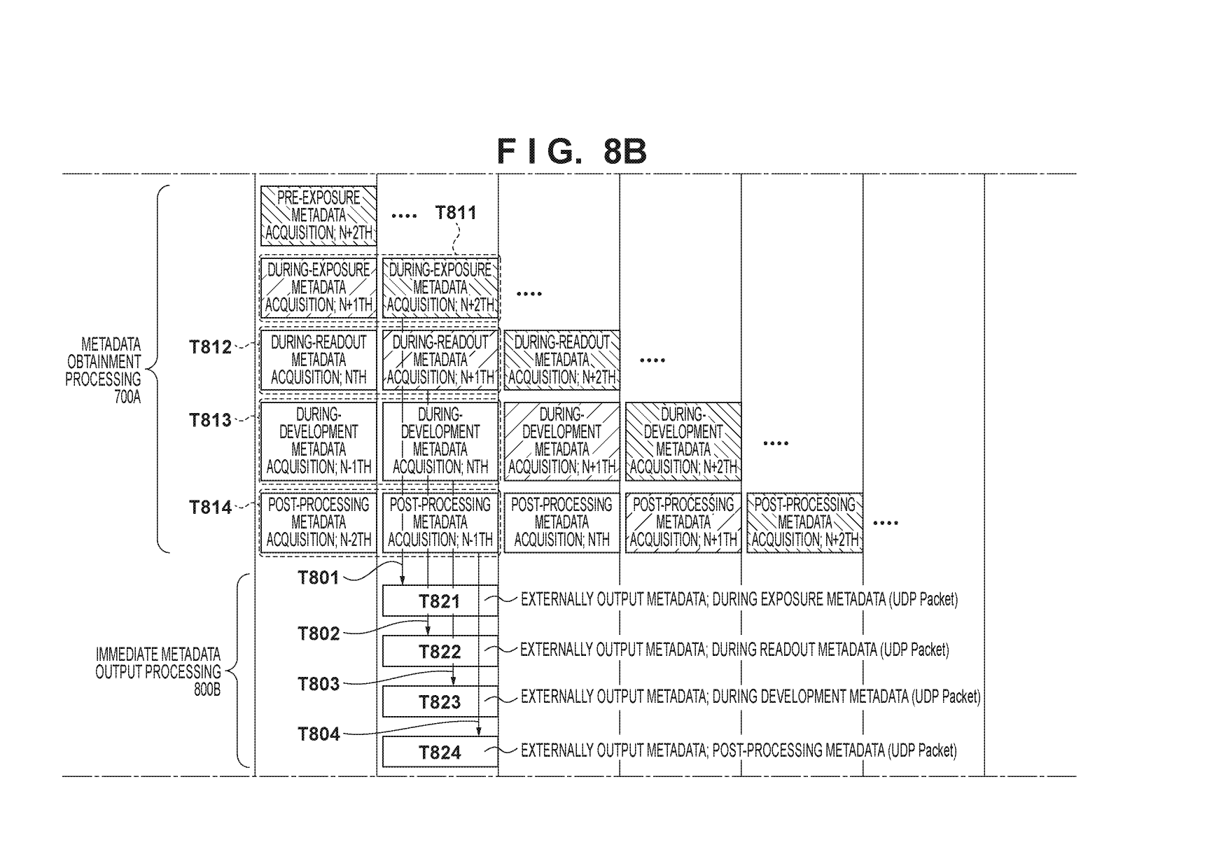

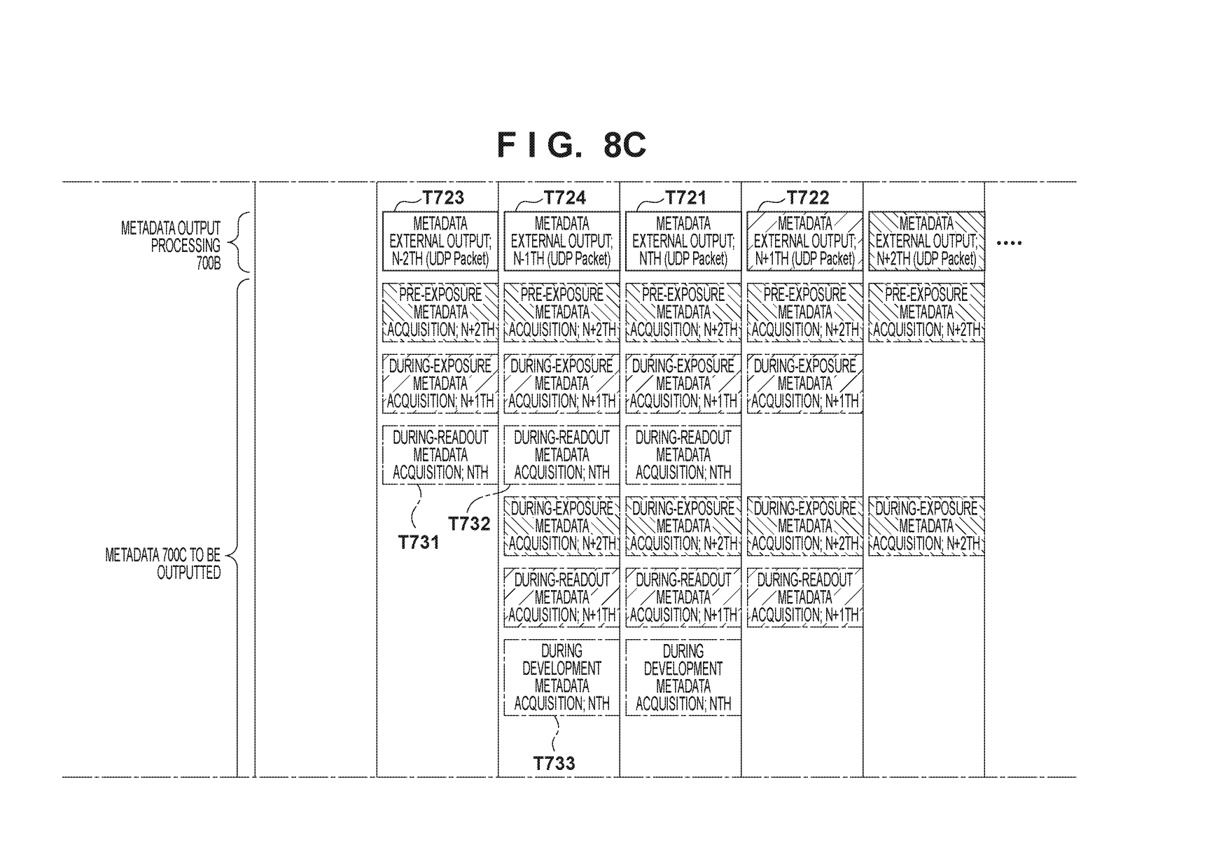

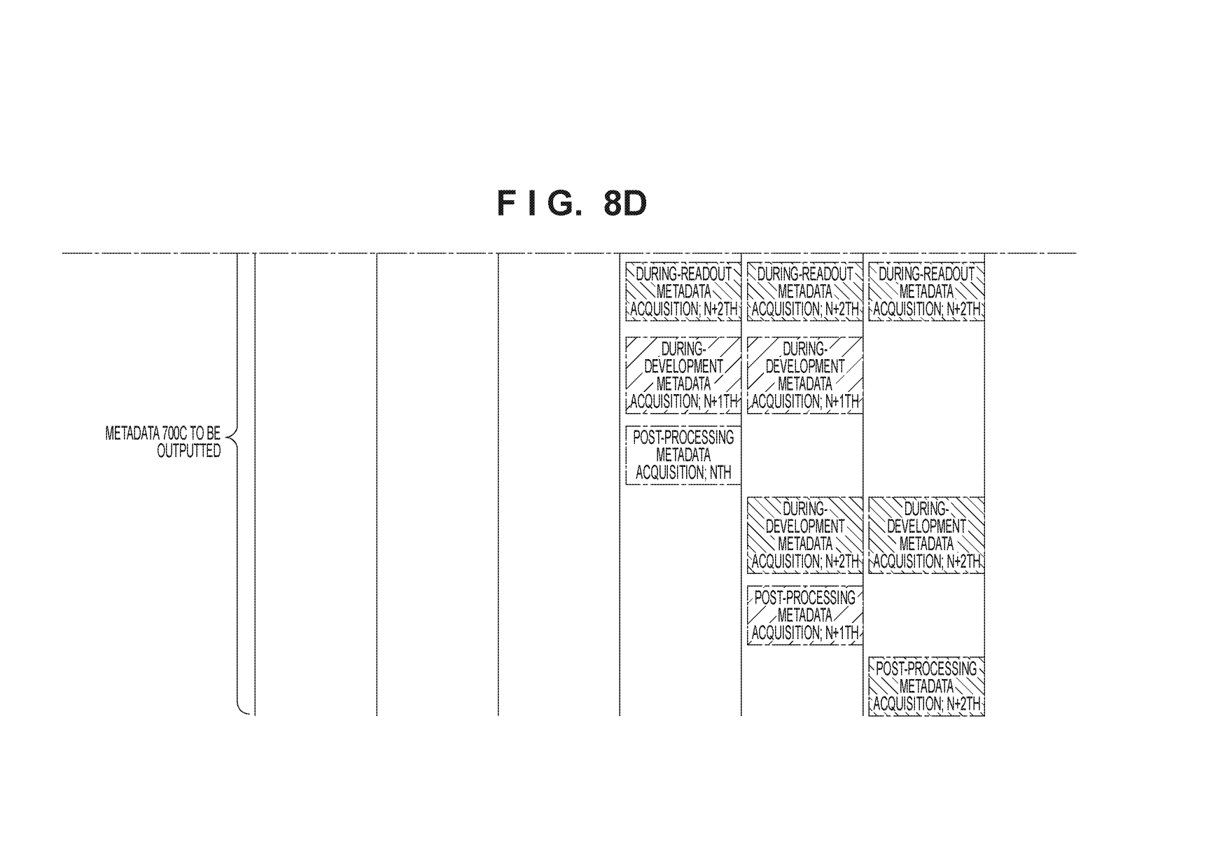

Next, the operation from image capture processing to image data output processing in the control processing of FIG. 3 by the image capture apparatus 100 of the present embodiment will be described with reference to FIGS. 8A-8D. Note that in FIGS. 8A-8D, similar processing to that in FIGS. 7A-7D is denoted by the same number as that in FIGS. 7A-7D, and description will be omitted.

An example of a VD period (VD2) in which sensor exposure of the (N + 2)th frame is being performed in the metadata obtainment processing of FIG. 8B will be described.

VD2 in FIG. 8B is a situation in which the in-exposure metadata of the frame N + 2 can be obtained at the timing of T801, the in-readout metadata of the frame N + 1 can be obtained at the timing of T802, the developing metadata of the frame N can be obtained at the timing of T803, and the post-processing metadata of the frame N - 1 can be obtained at the timing of T804.

When the in-exposure metadata of the frame N + 2 can be obtained at the timing of T801, the control unit 101 immediately outputs the metadata, and therefore obtains, from the volatile memory 105, all the pieces of in-exposure metadata, which is metadata of the identical type related to the (N - 2)th and subsequent frames scheduled to be synchronized at VD2. Then, a set 811 of the in-exposure metadata of the frame N + 1 and the frame N + 2 including the in-exposure metadata regarding the obtained frame N + 1 at the timing of T801 is output from the second output unit 110 at T821.

Similarly to the above processing, when the in-readout metadata, the developing metadata, and the post-processing metadata of the frame N + 1 can be obtained at the timings of T802, T803, and T804, respectively, all the pieces of metadata related to the frames at and after the frame N - 2 scheduled to be synchronized are obtained from the volatile memory 105. T812, T813, and T814 are sets of metadata obtained at T802, T803, and T804, and are output from the second output unit 110 at T822, T823, and T824.

According to the second embodiment described above, in addition to the processing of the first embodiment, when a part of the plurality of types of metadata generated from the image capture processing to the output processing of image data can be obtained, the obtained metadata of the identical type to the obtained metadata is immediately output as a set, and therefore the robustness against packet loss can be improved.

Note that, in the present embodiment, an example of externally outputting metadata obtained for each process separated by the vertical synchronization signal (VD), such as during exposure or during developments has been described, but the present disclosure is not limited to this. For example, it is also possible to perform external output in more detailed data units each time a T value or a distortion parameter can be obtained.

In the present embodiment, in addition to the output processing of metadata synchronized with the frame of the first embodiment, the processing of outputting metadata immediately at a time point when the metadata can be obtained has been described, but the output processing of metadata synchronized with the frame is not essential.

### Third Embodiment

Next, a third embodiment will be described.

In the first and second embodiments, an example has been described in which all pieces of metadata that can be obtained until image data of a certain frame is externally output are externally output, but when all pieces of metadata are externally output, processing loads at the image capture apparatus 100 and the image processing apparatus 200 increase. Therefore, in the third embodiment, an example in which the frequency in a case of externally outputting metadata in the first and second embodiments is changed according to the importance level of the metadata will be described.

In the third embodiment, the higher the frequency of outputting metadata is increased as the importance level of the real-time composite processing executed by the image processing apparatus 200 is higher.

For example, there is a high possibility that an unnatural image is rendered when the posture information of the image capture apparatus 100 is lost even in one frame, and therefore such metadata having a high importance level is output over a plurality of frames for each frame as in the first embodiment, or immediately output at the timing when information can be obtained as in the second embodiment, whereby robustness against packet loss can be improved.

Distortion parameters and T values (F values) are also exemplified as data in which there is a high possibility that an unnatural image is rendered when lost even in one frame, but a change in brightness of the image is less likely to be visually recognized than the posture information of the image capture apparatus 100, and therefore the importance level is made lower than the posture information of the image capture apparatus 100.

Furthermore, since the frame rate and the resolution are not information that changes for each frame and do not need to be output for each frame, it is possible to prevent enlargement in size of transmission data by limiting the number of times of outputting, for example, by thinning out frames to output or outputting only a predetermined number of frames when there is a change in information.

Thus, in the third embodiment, in a case where the importance level of the metadata decreases in the order of the posture information of the image capture apparatus 100, the information regarding the brightness of the image, and the information regarding the image capture processing, the frequency of outputting the metadata is reduced accordingly.

According to the third embodiment described above, it is possible to reduce the processing loads of the image capture apparatus 100 and the image processing apparatus 200 by externally outputting not all the pieces of metadata that can be obtained until the image data of a certain frame is externally output.

According to each of the above-described embodiments, a part of the plurality of types of metadata generated from the image capture processing to the output processing of the image data in the image capture apparatus is output from an output unit different from the output unit that outputs the image data. This enables the external apparatus to perform desired processing using a part of the metadata received previously from the image capture apparatus even in a case where, for example, the format of the image data is converted and the metadata added to the image data is no longer continuously output.

According to the present disclosure, it is possible to reduce generation of an unnatural image due to occurrence of packet loss.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-193200, filed November 1, 2024 which is hereby incorporated by reference herein in its entirety.

What is claimed is:

1. An image capture apparatus comprising:
a first generation unit that generates image data at a predetermined cycle;
a second generation unit that generates metadata regarding processing up to generation of the image data;
a first output unit that adds the metadata to the image data to output externally the image data; and
a second output unit that outputs externally, a plurality of times, predetermined information generated until the image data in the metadata is output, before the image data is output by the first output unit.

2. The apparatus according to claim 1, further comprising
an extraction unit that extracts the predetermined information to be output externally by the second output unit from the metadata generated by the second generation unit before the image data is output by the first output unit.

3. The apparatus according to claim 1, wherein
after the image data added with the metadata is output externally by the first output unit, the second output unit does not output externally predetermined information regarding image data to be output after the image data.

4. The apparatus according to claim 1, wherein
the metadata added to the image data and output by the first output unit includes same information as predetermined information regarding the image data.

5. The apparatus according to claim 1, wherein
the predetermined information includes information for synchronizing the image data to be output by the first output unit with the predetermined information to be output by the second output unit.

6. The apparatus according to claim 1, wherein
the second generation unit generates first metadata synchronized with first image data to be output by the first output unit and second metadata scheduled to be synchronized with second image data to be output after the first image data,
the first output unit adds the first metadata to the first image data to output externally the first image data, and
the second output unit outputs the second metadata when the first metadata to the first image data to output externally the first image data.

7. The apparatus according to claim 6, wherein
the second metadata includes predetermined information regarding the second image data.

8. The apparatus according to claim 1, wherein
the second output unit outputs externally the predetermined information generated by the second generation unit at a timing of obtaining the predetermined information.

9. The apparatus according to claim 8, wherein
the second output unit outputs externally, as a set, first predetermined information regarding first image data generated by the second generation unit before the first image data is output by the first output unit and second predetermined information regarding second image data of a same type as the first predetermined information generated by the second generation unit before the second image data output before the first image data is output by the first output unit.

10. The apparatus according to claim 1, wherein
the second output unit changes a frequency of outputting the predetermined information depending on an importance level of processing to be executed externally using the predetermined information.

11. The apparatus according to claim 10, wherein
the second output unit increases a frequency of outputting the predetermined information as an importance level of the processing to be executed externally is higher.

12. The apparatus according to claim 11, wherein
the predetermined information includes posture information of the image capture apparatus, information regarding brightness of an image, and information regarding image capture processing, and
the frequency decreases in an order of the posture information of the image capture apparatus, the information regarding brightness of the image, and the information regarding the image capture processing.

13. The apparatus according to claim 1, further comprising an image capture unit that captures an image at a predetermined frame rate,
wherein the image data is moving image data,
the metadata is information associated with the moving image data to be generated for each frame of the moving image data, and
the metadata includes metadata before exposure by the image capture unit, metadata during exposure by the image capture unit, metadata during readout of an image signal from the image capture unit, metadata during development of the image signal, and metadata regarding post-processing of developed image data.

14. The apparatus according to claim 1, wherein
the predetermined information is information to be used for processing to be executed externally, and
the processing to be executed externally is processing of compositing the image data with CG data in real time.

15. The apparatus according to claim 13, wherein
the predetermined information includes a time code or a frame number of a frame of image data scheduled to be output by the first output unit.

16. The apparatus according to claim 13, wherein
the predetermined information includes information corresponding to a time of a difference from a time code synchronized with image data to be output from the first output unit or a number of frames of a difference from a frame number.

17. The apparatus according to claim 1, wherein
the first output unit is compliant with Serial digital interface (SDI) standard, and
the second output unit is compliant with User Datagram Protocol (UDP) standard.

18. A control method of an image capture apparatus, the control method comprising:
generating image data at a predetermined cycle;
generating metadata regarding processing up to generation of the image data;
adding the metadata to the image data to output externally the image data from a first output unit; and
outputting externally, from a second output unit, a plurality of times, predetermined information regarding the image data generated until the image data in the metadata is output, before the image data is output from the first output unit.

19. A non-transitory computer-readable storage medium storing a program for causing a computer to function as an image capture apparatus comprising:
a first generation unit that generates image data at a predetermined cycle;
a second generation unit that generates metadata regarding processing up to generation of the image data;
a first output unit that adds the metadata to the image data to output externally the image data; and
a second output unit that outputs externally, a plurality of times, predetermined information generated until the image data in the metadata is output, before the image data is output by the first output unit.
